(19) United States
(12) Patent Application Publication
(10) Pub. No.: US 2026/0299672 A1
(43) Pub. Date: Oct. 1, 2026

(54) DYNAMIC VOLTAGE AND FREQUENCY SCALING (DVFS) WITH DYNAMIC REFERENCE VOLTAGE

(71) Applicant: QUALCOMM Incorporated, San Diego, CA (US)

(72) Inventors: Dinesh Kumar CHOUDHARY, Tonk (IN); Sai Sneha Venkata YESANTARAO, Hyderabad (IN); Sai Sumanth MANCHUKONDA, Rangareddy (IN)

(21) Appl. No.: 19/090,240

(22) Filed: Mar. 25, 2025

(51) Int. Cl. G06F 1/3296

(52) U.S. Cl. CPC G06F 1/3296

(57) ABSTRACT

A method for dynamically controlling power consumption of an electronic device is disclosed. The electronic device includes at least one processor operable under a plurality of performance states and a power management device configured to power the processor. The method includes generating a request indicating a selected performance state from the plurality of performance states for the processor to shift to, determining a target supply voltage associated with the selected performance state, retrieving a plurality of historical supply voltages associated with the selected performance state, determining a reference voltage from the plurality of historical supply voltages, and setting the power management device to ramp to the reference voltage and step to the target supply voltage from the reference voltage.

### FIELD OF TECHNOLOGY

The technology discussed below generally relates to power management of an electronic device (e.g., having a system-on-chip (SoC)), and in particular, to methods, systems, and non-transitory computer-readable media for controlling power consumption and device performance of an SoC-based electronic device based on dynamic voltage and frequency scaling (DVFS).

### BACKGROUND

Computing devices are ubiquitous. Some computing devices are portable such as smartphones, tablets and laptop computers. In addition to the primary function of these devices, many include elements that support peripheral functions. For example, a cellular telephone may include the primary function of enabling and supporting cellular telephone calls and the peripheral functions of a still camera, a video camera, a music player, global positioning system (GPS) navigation, web browsing, sending and receiving emails, sending and receiving text messages, push-to-talk capabilities, etc.

Some conventional designs for handheld portable computing devices include multiple processors and/or processors with multiple cores to support the various primary and peripheral functions desired for a particular computing device. Such designs often further integrate analog, digital and radio-frequency circuits or functions on a single substrate and are commonly referred to as a system-on-chip (SoC). These different circuits and functions will often require different operating frequencies and supply voltage levels. The desire to conserve energy stored in a battery that powers such portable devices has led to the implementation of dynamic power management techniques.

A dynamic power management technique may use a power management integrated circuit (PMIC) to dynamically adjust supply voltage levels to different circuits in the SoC. The PMIC is typically disposed adjacent to the SoC on a main logic board and provides multiple direct current (DC) power supply rails to the SoC via conductive wires formed on the main logic board. The PMIC provides a plurality of power rails configured to drive operations of the SoC. Power characteristics (e.g., power consumption, current, and voltage) are monitored and controlled for each power rail and a corresponding portion of the SoC. It would be beneficial to have an efficient and flexible power management mechanism to manage power provided by the PMIC.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In accordance with an aspect of the disclosure, a method for dynamically controlling power consumption of an electronic device is disclosed. The electronic device includes at least one processor operable under a plurality of performance states and a power management device configured to power the processor. The method includes generating a request indicating a selected performance state from the plurality of performance states for the processor to shift to, determining a target supply voltage associated with the selected performance state, retrieving a plurality of historical supply voltages associated with the selected performance state, determining a reference voltage from the plurality of historical supply voltages, and setting the power management device to ramp to the reference voltage and step to the target supply voltage from the reference voltage.

In accordance with another aspect of the disclosure, a system for dynamically controlling power consumption of an electronic device is disclosed. The system includes a processor, a power management processor associated with the processor, a voltage regulator providing a supply voltage to the processor, and a controller commanding the voltage regulator to provide the supply voltage. The controller is configured to receive a request generated from the power management processor. The request indicates a performance state for the processor to shift to and a target supply voltage associated with the performance state. The controller is also configured to retrieve a plurality of historical supply voltages associated with the performance state, determine a reference voltage from the plurality of historical supply voltages, and command the voltage regulator to shift the supply voltage to the reference voltage first then from the reference voltage to the target supply voltage.

In accordance with yet another aspect of the disclosure, an apparatus is disclosed. The apparatus includes a processor operable to shift under a plurality of performance states, a first means for determining a next performance state for the processor from the plurality of performance states and a target supply voltage associated with the next performance state, and a second means for controlling a supply voltage for the processor configured to retrieve a plurality of historical supply voltages associated with the next performance state, determine a reference voltage based on the historical supply voltages, and ramp the supply voltage to the determined reference voltage and step to the target supply voltage from the determined reference voltage.

Other aspects, features, and implementations of the present disclosure will become apparent to those of ordinary skill in the art, upon reviewing the following description of specific, exemplary implementations of the present disclosure in conjunction with the accompanying figures. While features of the present disclosure may be discussed relative to certain implementations and figures below, all implementations of the present disclosure can include one or more of the advantageous features discussed herein. In other words, while one or more implementations may be discussed as having certain advantageous features, one or more of such features may also be used in accordance with the various implementations of the disclosure discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various implementations and to explain various principles and advantages in accordance with the present disclosure.

FIG. 1 is a block diagram of an example system module in an electronic device, such as a portable computing device (PCD), in accordance with some implementations.

FIG. 2 is a block diagram of a power management system of the electronic device shown in FIG. 1, in accordance with some implementations.

FIG. 3 is a block diagram of a processing cluster including one or more processors coupled with a core power reduction (CPR) controller and a power management integrated circuit (PMIC), in accordance with some implementations.

FIG. 4 illustrates two voltage-transition approaches in response to a dynamic voltage and frequency scaling (DVFS) request, in accordance with some implementations.

FIG. 5 illustrates an exemplary data structure recording historical settled voltages associated with previous DVFS requests under various performance states and operating conditions, in accordance with some implementations.

FIGS. 6A and 6B illustrate a workflow in determining a dynamic reference voltage in response to a DVFS request, in accordance with some implementations.

FIGS. 7A and 7B illustrate another workflow in determining a dynamic reference voltage in response to a DVFS request, in accordance with some implementations.

FIG. 8 is a flowchart illustrating an exemplary method for managing DVFS events, in accordance with some implementations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In this description, the term “exemplary” is used herein to mean “serving as an example, instance, or illustration.” Any aspect described herein as “exemplary” is not necessarily to be construed as preferred or advantageous over other aspects.

The term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The term “portable computing device” or “PCD” is intended to refer to any device operating on a limited-capacity rechargeable power source, such as a battery or capacitor. Technological advances in rechargeable batteries and in wireless communication (3G, 4G, 5G, etc.) have enabled PCDs with multiple capabilities. Examples of such PCDs include cellular telephones, satellite telephones, pagers, personal digital assistants (PDAs), smartphones, navigation devices, smartbooks or e-readers, media players, and laptop or tablet computers with wireless connectivity, among others.

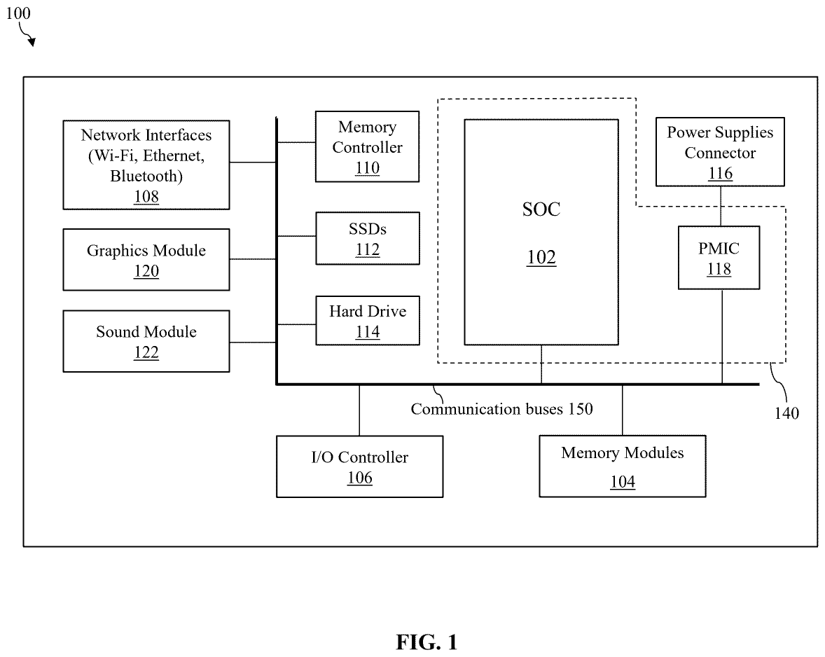

FIG. 1 is a block diagram of an example system module 100 in an electronic device, such as a portable computing device (PCD), in accordance with some implementations. The system module 100 includes at least a system-on-chip (SoC) 102 having one or more processors, memory modules 104 for storing programs, instructions, and data, an input/output (I/O) controller 106, one or more communication interfaces such as network interfaces 108, and one or more communication buses 150 for interconnecting these components. In some implementations, the I/O controller 106 enables the SoC 102 to communicate with an I/O device (e.g., a keyboard, mouse, or touchscreen) via a universal serial bus (USB) interface. The network interfaces 108 may include one or more interfaces for Wi-Fi, Ethernet, and Bluetooth networks, facilitating data exchange between the electronic device and an external source, such as a server or another electronic device. The communication buses 150 may include circuitry (sometimes referred to as a chipset) that interconnects and manages communications among various system components within the system module 100.

The memory modules 104 may include high-speed random-access memory (RAM), such as DRAM, SRAM, DDR RAM, or other solid-state memory devices. In some implementations, the memory modules 104 further include non-volatile storage, such as magnetic disk storage, optical disk storage, flash memory, or other solid-state storage devices. Additionally, the memory modules 104 or their non-volatile memory components may include a non-transitory computer-readable storage medium. In some implementations, dedicated memory slots within the system module 100 accommodate the memory modules 104, integrating them into the system when inserted.

In some implementations, the system module 100 may further include one or more of the following components: a memory controller 110 that manages communication between the SoC 102 and memory components, including the memory modules 104; Solid-state drives (SSDs) 112 that store data using integrated circuits and, in many cases, are based on NAND or NOR memory configurations; a hard drive 114, a conventional electromechanical storage device that retrieves and stores digital data on magnetic disks; a power supply connector 116 with one or more direct current (DC) power supply interfaces, each configured to receive a distinct DC supply voltage; a power management integrated circuit (PMIC) 118 that regulates the received DC supply voltages and converts them into desired internal voltages, such as 5V, 3.3V, or 1.8V, to power various system components (e.g., processor cores within the SoC 102); a graphics module 120 that generates video output signals formatted for one or more display devices; a sound module 122 that facilitates the input and output of audio signals under software control. The communication buses 150 also interconnect and manage communications among the components 110-122, ensuring efficient data exchange within the system.

One skilled in the art will recognize that emerging non-transitory computer-readable storage media technologies may also be used for data storage in the memory modules 104 and SSDs 112. Such advancements include, but are not limited to, storage media manufactured from biological materials, nanowires, carbon nanotubes, and individual molecules. While these technologies remain in development and have yet to be commercialized, they hold potential for future integration into electronic devices.

In some implementations, the SoC 102 is housed within a semiconductor package that includes one or more integrated circuits. Each integrated circuit may integrate a subset of components, such as one or more microprocessor or CPU cores, memory, input/output ports, and secondary storage, onto a single substrate. Similarly, the PMIC 118 is implemented in a semiconductor package comprising one or more integrated circuits, each formed on a single substrate. The SoC 102 is configured to receive one or more internal supply voltages (also referred to as rail voltages) from the PMIC 118 via dedicated power rails. In some implementations, the SoC 102 and the PMIC 118 may be both mounted on a main logic board, positioned in separate areas, and electrically connected via conductive traces embedded within the board. Alternatively, the SoC 102 and PMIC 118 may be vertically stacked within an integrated semiconductor device 140. In this configuration, the semiconductor dies of the SoC 102 and PMIC 118 are electrically connected without relying on the conductive traces of the main logic board. This vertical integration reduces the length of electrical connections between the SoC 102 and PMIC 118, minimizing performance degradation caused by signal routing through the board.

In some implementations, the PMIC 118 is designed as a generic power management solution capable of supporting various types of SoCs 102 across different electronic devices. Regardless of whether the PMIC 118 and SoC 102 are positioned side by side or vertically stacked, the PMIC 118 maintains a consistent footprint on the main circuit board, while the SoC 102 may vary in size depending on its integrated electronic modules. In some implementations, the PMIC 118 may include a plurality of voltage regulator units arranged in a field-programmable array. These voltage regulator units may be identical or include multiple types. In a given electronic device, control signals are generated based on the rail voltages and rail currents required by the SoC 102 and other system components. For each power rail, a corresponding control signal selects a subset of voltage regulator units within the field-programmable array of the PMIC 118. The selected voltage regulator units collectively provide the required rail voltage and rail current to the respective power rail. As such, the PMIC 118 is dynamically reconfigured via these control signals to supply the appropriate rail voltages and currents to the SoC 102 and other connected components. Each voltage regulator unit within the PMIC 118 is either activated to drive a specific power rail or remains redundant depending on the control signals received.

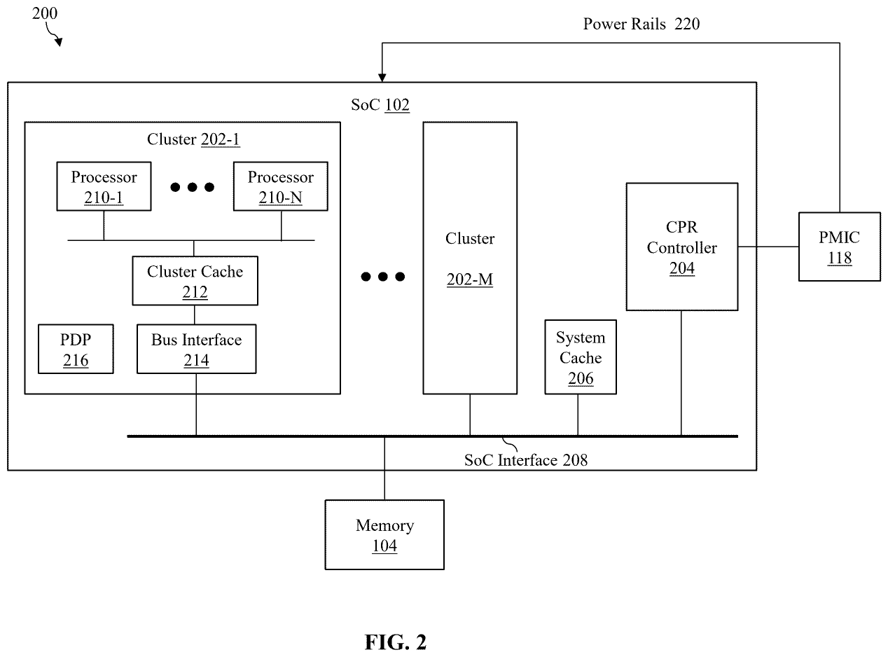

FIG. 2 is a block diagram of an example electronic device 200 having one or more processing clusters 202 (e.g., first processing cluster 202-1, M^{th} processing cluster 202-M), in accordance with some implementations. The electronic device 200 includes an SoC 102, a memory 104, and a PMIC 118. The SoC 102 includes the one or more processing clusters 202, a core power reduction (CPR) controller 204, a system cache 206, and an SoC interface 208. The SoC interface 208 is interconnect architecture that facilitates data and control transmission across all linked components, i.e., communication between a subset of the processing clusters 202, CPR controller 204, memory 104, and PMIC 118. The SoC interface 208 has a shared bus configuration or a point-to-point fabric configuration.

Each processing cluster 202 includes one or more processors (also referred to as processing cores) 210, a cluster cache 212, a bus interface 214, and a power and debug management processor (PDP) 216. The cluster cache 212 is coupled to one or more processors 210 and maintains one or more request queues for one or more processors 210. In some implementations, each processor 210 further includes a core cache (not shown in FIG. 2) that is optionally split into an instruction cache and a data cache, and the core cache stores instructions and data that can be immediately executed by the respective processor 210. In an example, the first processing cluster 202-1 includes first processor 210-1 to N^{th} processor 210-N, where N is an integer larger than 1. In some implementations, the SOC 102 only includes a single processing cluster 202-1. Alternatively, in some implementations, the SOC 102 includes at least an additional processing cluster 202.

In some implementations, the one or more processing clusters 202 are configured to provide a central processing unit for an electronic device and are associated with a hierarchy of caches. For example, the hierarchy of caches includes three levels that are distinguished based on their distinct operational speeds and sizes. For the purposes of this application, a reference to “the speed” of a memory (including a cache memory) relates to the time required to write data to or read data from the memory (e.g., a faster memory has shorter write and/or read times than a slower memory), and a reference to “the size” of a memory relates to the storage capacity of the memory (e.g., a smaller memory provides less storage space than a larger memory). The core cache, cluster cache 212, and system cache 206 correspond to a first level (L1) cache, a second level (L2) cache, and a third level (L3) cache, respectively. Each core cache holds instructions and data to be executed directly by a respective processor 210, and has the fastest operational speed and smallest size among the three levels of memory. For each processing cluster 202, the cluster cache 212 is slower operationally than the core cache and bigger in size, and holds data that is more likely to be accessed by processors 210 of respective processing cluster 202. The system cache 206 is shared by the plurality of processing clusters 202, and bigger in size and slower in speed than each core cache and cluster cache 212.

The processing clusters 202 issue prefetch requests to extract the instructions and data to be held by each core cache from the cluster cache 212, system cache 206, or memory 104. If the prefetch requests are satisfied by the cluster cache 212, the cluster cache 212 provides the instructions and data to the respective core cache for execution by the processors 210. Conversely, if the prefetch requests are not satisfied by the cluster cache 212, the prefetch requests are sent to the cache 206 via the bus interface 214 to extract the instructions and data. If the prefetch requests are satisfied by the cache 206, the cache 206 provides the instructions and data via the bus interface 214 to the cluster cache 212, which further passes the instructions and data to the respective core cache for execution by the processors 210. Conversely, if the prefetch requests are not satisfied by the system cache 206, the prefetch requests are sent to the memory 104 external to the SoC 102 to extract the instructions and data. The memory 104 provides the instructions and data to the system cache 206, which passes the instructions and data to the cluster cache 212 and then to the respective core cache.

Additionally, the processing clusters 202 issue memory access requests to write data into and read data from the cluster cache 212, system cache 206, or memory 104 during normal operation of each processing cluster 202. Each memory access request is passed sequentially from the cluster cache 212, system cache 206, and memory 104, until the respective memory access request reaches a target cache or memory. Data to be written into the target cache or memory are passed sequentially from the cluster cache 212, system cache 206, and memory 104, until the respective data reach the target cache or memory. In contrast, data read from the target cache or memory are provided directly to the respective core caches to be used by the processors 210.

For each processing cluster 202, the PDP 216 manages power consumption of the respective processing cluster 202 and provides debug infrastructure for the respective processing cluster 202. Operations of the processing clusters 202, PMIC 118, system cache 206, and memory 104 consume power and create heat on the electronic device 200. The PDP 216 is applied to manage power consumptions of the electronic device 200 from a firmware level. Specifically, for each respective processing cluster 202, the PDP 216 is configured to obtain performance information about the one or more processors 210, select one of a plurality of predefined power performance states (P-states) for each of a plurality of processors, or execute power instructions to transition a processor from a first performance state (e.g., PS1) to a second performance state (e.g., PS2), and provide debug infrastructure to perform debugging of a respective processor (e.g., the first processor 210-1 or a different processor) of the one or more processors 210 of the respective processing cluster 202. Each of the performance states corresponds to predefined set of power and performance settings of the processors. The power instructions are executed in accordance with the obtained performance information and independently of respective performance states of other processors 210 in the one or more processors 210. In some embodiments, the one or more debug instructions are executed to perform debugging of the processors.

In some implementations, the PDP 216 manages the P-state aggregation and then communicates the decision to DVFS state machine 218. The DVFS state machine 218 interacts with the CPR controller 204 for voltage changes, which is configured to define power allocations to the one or more processing clusters 202, and PLL for frequency changes. Optionally, the CPR controller 204 is external to any of the one or more processing clusters 202 of the electronic device. Optionally, the CPR controller 204 is disposed internal within one of the one or more processing clusters 202, (e.g., the first processing cluster 202-1). The CPR controller 204 is further coupled to a PMIC 118. The CPR controller 204 is configured to communicate with the PMIC 118 having one or more voltage regulators, thereby enabling the respective processing cluster 202 to be powered by one or more power rails 220 driven by the voltage regulators of the PMIC 118. By these means, the PDP 216, DVFS state machine 218, and CPR controller 204 form a hierarchical power management system that is configured to manage power consumption of a multiprocessor electronic device 200 from both a firmware level and a system level.

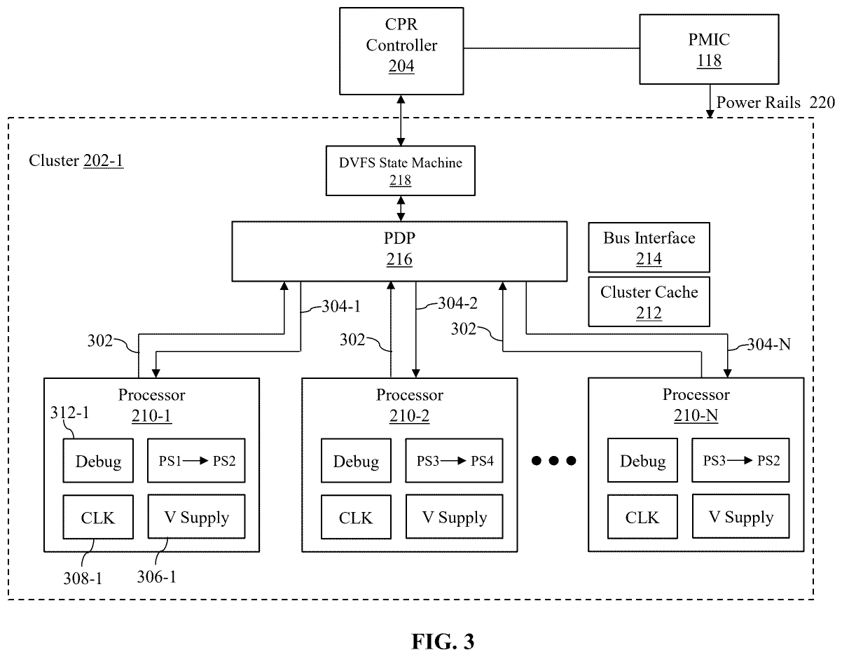

As shown in FIG. 3, the first processing cluster 202-1 can include one or more processors 210, a cluster cache 212, a bus interface 214, and a PDP 216. In some implementations, the one or more processors 210 corresponds to either a single processor 210-1 or multiple processors labeled 210-1 through 210-N (where N>1). The cluster cache 212, coupled to each processor 210, may maintain request queues, supply instructions/data to each processor's local cache, and fetch missing instructions/data from the system cache 206 and/or memory 104. The bus interface 214 facilitates communication between cluster 202-1 and other components, such as other processing clusters 202, the CPR controller 204, the system cache 206, memory 104, or the PMIC 118.

The PDP 216 is coupled to each processor 210 within cluster 202-1 and manages power consumption and/or debugging. In some implementations, the PDP 216 periodically obtains performance information 302 from the processors 210, such as instruction activity levels, energy usage, temperature measurements, and counts of performance limit breaches (e.g., overcurrent breaches). A processor 210 is deemed to have “breached” a performance limit if it exceeds a threshold number of samples (e.g., 80% of all current samples) over a specified interval (e.g., 100 milliseconds).

In some implementations, each processor 210 can operate in one of multiple performance states (also referred to as P-states), each associated with certain power and frequency settings. A “high” performance state might represent the processor's theoretical peak but cannot be sustained indefinitely. A “nominal” performance state is a maximum level the processor can sustain under ideal conditions, and a “guaranteed” performance state is the maximum sustainable level subject to real-world constraints such as power budgeting and thermal limits. All processors 210 in cluster 202-1 may operate at their nominal or guaranteed performance states simultaneously.

Based on the performance information 302, the PDP 216 can issue instructions (e.g., instructions 304-1) to transition a particular processor 210-1 from a first performance state (PS1) to a second performance state (PS2). In many cases, PS2 differs from PS1 by having a different clock frequency 308-1 and/or supply voltage 306-1. The PDP 216 may adjust the performance state of one processor 210 without altering the states of the others, or it may coordinate across multiple processors so that overall power budgets or performance targets are satisfied. For example, if the PDP 216 detects that the temperature of processor 210-1 exceeds a predefined threshold or is rising too quickly, it may lower that processor's power consumption by placing it into a PS2 having reduced voltage 306-1 and/or clock speed 308-1. Conversely, if the temperature drops below a threshold, the PDP 216 may increase the processor's power by transitioning it to a higher-power performance state. A similar mechanism can be triggered in response to overcurrent breaches. If the count of current-limit breaches for a processor 210-1 exceeds a first threshold, the PDP 216 may move it to a lower-power PS2; if that count then falls below a second threshold, the PDP 216 may raise the processor 210-1 to a higher-power performance state.

In some implementations, the PDP 216 also executes debug instructions to diagnose issues in any of the processors 210, such as the processor 210-1 that has just transitioned states. Debugging can occur while the processor is running an application and may be carried out by a dedicated debug module within PDP 216, sometimes in conjunction with a local debugging unit 312-1 on each processor.

Performance-state transitions may involve changing voltage 306-1 and/or clock frequency 308-1 of a particular processor independently from the other processors in cluster 202-1. As another example, the PDP 216 can execute separate instructions (e.g., instructions 304-2) to transition a different processor 210-2 from a third performance state PS3 to a fourth performance state PS4. These transitions may be entirely independent of the first processor's performance states (PS1 and PS2).

In further examples, the PDP 216 can dynamically adjust a first processor 210-1's performance state in response to another processor turning on or off. For instance, if a third processor 210-3 transitions from an off-state to an on-state and increases the overall power draw, the PDP 216 might instruct processor 210-1 to drop from PS1 to a lower-power lower-frequency PS2 to accommodate the third processor's power needs. Conversely, if an N^{th} processor 210-N switches from on-state to off-state and thereby frees up power, the PDP 216 may cause processor 210-1 to boost its performance from PS2 to a higher-power higher-frequency PS1. In either scenario, PS1 and PS2 can refer to active states with different performance levels or an active/standby combination, depending on the design constraints.

Through these mechanisms, the PDP 216 within processing cluster 202-1 can dynamically balance performance and power consumption among multiple processors 210, while also providing debugging capabilities based on the collected performance information 302.

The CPR controller 204 is coupled to the PDP 216 of the first processing cluster 202-1 (e.g., via the bus interface 214) and jointly manages power consumption of the cluster 202-1 with the PDP 216. In one embodiment, the CPR controller 204 is external to any of the one or more processing clusters 202 of the electronic device. In another embodiment, the CPR controller 204 is internal to one of the processing clusters 202 (e.g., the first processing cluster 202-1) while still defining power allocations for all the processing clusters 202.

In operation, the PDP 216 provides cluster performance information, which is derived from or based on performance information 302 of the processors 210 in the first processing cluster 202-1, to the CPR controller 204. The cluster performance information may be collected by an aggregator. The PDP 216 may then generate a power allocation for the first processing cluster 202-1 based on that performance information, along with similar information gathered from other processing clusters 202. In response to receiving the power allocation, the PDP 216 assigns or adjusts performance states of each processor 210 within the first processing cluster 202-1 accordingly. The power allocation is also referred to as a power budget. This budget specifies a maximum amount of power each cluster 202 may consume. In some examples, multiple processing clusters 202, caches 206, and memory 104 are grouped into distinct power domains. The PDP 216 can then assign power allocations to these power domains. For a power domain that includes the first processing cluster 202-1, the allocated power may be subdivided for local use in the first processing cluster 202-1, subject at least in part to control by the PDP 216.

In addition to providing these cluster-level power allocations, the CPR controller 204 also controls the PMIC 118 to supply appropriate power rails to the first processing cluster 202-1 (and, to other clusters 202). For instance, when performance demands increase in the first processing cluster 202-1, the CPR controller 204 may instruct the PMIC 118 to raise the voltage supply to ensure the cluster's processors 210 can operate at higher performance states. Conversely, when lower performance states suffice, the CPR controller 204 can request reduced voltage supply from the PMIC 118 to conserve power across the system.

Thus, the PDP 216 handles fast, fine-grained adjustments to individual processors 210 within the first processing cluster 202-1, while the CPR controller 204 enforces broader, system-wide power and performance objectives. By coordinating these two control levels—and by leveraging the PMIC 118 to supply power rails in accordance with the CPR controller's allocations—the system achieves both efficiency and responsiveness in managing performance states of the processing clusters. The local PDP-based voltage and frequency control, coordinated by the systemwide CPR controller 204 and supported by the PMIC 118, aligns with a broader class of techniques known collectively as dynamic voltage and frequency scaling (DVFS). By adjusting supply voltages and clock frequencies according to real-time workload demands, DVFS further refines the balance between performance and power consumption.

In modern integrated circuit designs, DVFS is widely employed to balance performance requirements against power consumption. This technique involves adjusting the supply voltage and operating frequency of a processor in real time, based on ongoing workload conditions. As discussed above, during heavy computational demand, both the operating voltage and frequency can be increased to achieve higher performance; in lower-load situations, these parameters may be reduced to conserve power. The series of performance states define these distinct combinations of voltage supplies and frequency operating points.

Transitioning between performance states requires coordination among multiple hardware and firmware components. Once a transition is deemed necessary, specialized DVFS state machines manage the timing sequence of voltage and frequency changes, along with any required intermediate steps. For instance, increasing voltage prior to increasing frequency is essential to prevent timing errors, while decreasing frequency before lowering voltage ensures stable operation. Additional hardware blocks often monitor fast changes in current (di/dt) to mitigate the risk of voltage noise or other undesirable effects during these transitions. However, the PDP 216 and the CPR controller 204 often operate at different time scales. Because the PDP 216 is local to the first processing cluster 202-1, it can transition a processor 210-1 from one performance state (e.g., PS1) to another performance state (e.g., PS2) more quickly compared to voltage transitions executed by the CPR controller 204 and the PMIC 118. The relatively longer settling time of voltage adjustments through the coordination between the CPR controller 204 and the PMIC 118 introduces transition latency.

In other words, despite the potential energy savings and performance improvements offered by DVFS, frequent transitions can introduce overhead. In systems where the DVFS or advanced autonomous DCVS frameworks are triggered as frequently as once every millisecond, the latency of each transition, which can approach hundreds of microseconds, imposes a significant impact on overall performance and energy efficiency. A substantial fraction of this transition latency is commonly attributed to settling times during voltage adjustments through the coordination between the CPR controller 204 and the PMIC 118. These settling times can approach tens of millivolts of final voltage calibration, potentially leading to a lengthy loop of incremental voltage steps. As the operating frequency of performance state switches increases, this transition latency can become a bottleneck, negatively affecting both power usage and system responsiveness.

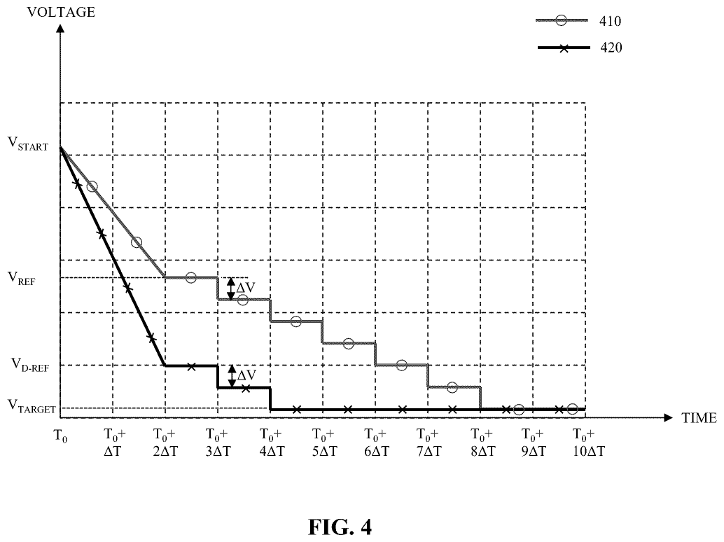

In FIG. 4, two voltage-transition approaches through the coordination between the CPR controller 204 and the PMIC 118 are shown for moving from a starting supply voltage V_{START} (e.g., an initial voltage after a cold boot or a previously settled voltage) down to a target voltage V_{TARGET} after a performance-state (P-state) change is triggered. The first approach, illustrated by curve 410, begins each transition from a fixed reference voltage V_{REF}. By contrast, the second approach, illustrated by curve 420, leverages a dynamic reference voltage V_{D-REF} that is closer to V_{TARGET}, thereby reducing the time taken to transit through the whole voltage range (i.e., from V_{START} to V_{TARGET}).

More specifically, the curve 410 exemplifies a “nominal” approach in which the system always moves to a fixed reference voltage V_{REF} before stepping down (or up) to the target voltage to settle at V_{TARGET}. Each incremental step in this approach typically has a small amplitude ΔV (e.g., 4 mV) and is followed by a settling time ΔT (e.g., 10 microseconds) to ensure stable operation. As illustrated in the implementation, the voltage transitions in the curve 410 might occur at times T₀, T₀+ΔT, T₀+2ΔT, T₀+3ΔT, and so on, until V_{TARGET} is reached at T₀+8ΔT. For example, if V_{REF} is initially 836 mV, the regulator may step the output voltage down to 832 mV, then 828 mV, 824 mV, 820 mV, 816 mV, and finally 812 mV (i.e., V_{TARGET}). Each of these six steps incurs its own settling time, and the total transition period (i.e., 6ΔT from V_{REF} to V_{TARGET} or 8ΔT from V_{START} to V_{TARGET}) can thus accumulate to tens of microseconds, often on the order of 60-80 microseconds or more, depending on the exact ΔV and ΔT values.

In some implementations, the fixed reference voltage V_{REF} is set equal to the ceiling voltage allowed by the PMIC 118. For example, the range of voltages that the PMIC 118 allows may be fixed (e.g., 800 mV to 836 mV), and the maximum allowed voltage (e.g., 836 mV) is referred to as the ceiling voltage and the minimum allowed voltage (e.g., 800 mV) is referred to as the floor voltage. The “nominal” approach may begin every transition from the fixed ceiling voltage, then steps downward in small increments until the system reaches its final operating voltage. While this approach provides a predictable starting point, it can be inefficient: the voltage rail spends excessive time at higher-than-necessary levels, which both delays the completion of the transition and increases transient power consumption. In addition, the fixed reference voltage does not adapt to changes in conditions such as temperature or prior settling behavior, and therefore remains a suboptimal “one-size-fits-all” setting.

In contrast, the curve 420 illustrates an “accelerated” approach in which the CPR controller 204 selects (or computes) an intermediate dynamic reference voltage V_{D-REF} that lies closer to V_{TARGET}. Because the range between the dynamic reference voltage V_{D-REF} and the target voltage V_{TARGET} is significantly smaller than the above discussed gap between V_{REF} and V_{TARGET}, fewer incremental steps are needed. Referring again to the example of ΔV having a 4 mV step size, the regulator might first move swiftly to a selected (or computed) intermediate V_{D-REFT} of 820 mV (rather than going all the way back to 836 mV), and then perform only two or three small 4 mV decrements, such as 820 mV→816 mV→812 mV, to reach the target voltage of 812 mV (i.e., V_{TARGET}). Each step still requires a settling time ΔT (e.g., 10 microseconds), but because the number of steps is fewer, the total transition time can shrink to as little as 20-40 microseconds ((i.e., 2ΔT from V_{D-REF} to V_{TARGET} or 4ΔT from V_{START} to V_{TARGET}), depending on the exact ΔV and ΔT values.

As shown in FIG. 4, the net effect is that the curve 420 converges on V_{TARGET} more quickly than the curve 410. By minimizing both the number of voltage steps and the time spent at higher voltages, this dynamic-reference approach not only shortens transition latency but also reduces power consumption. In systems where voltage transitions are triggered frequently—e.g., as often as once every millisecond with performance-state updates—these time savings can significantly improve overall performance, energy efficiency, and responsiveness.

As a result, the curve 420 reaches V_{TARGET} faster than the curve 410, reducing the duration during which the supply rail remains at unnecessarily high voltages. In some embodiments, this faster approach can shorten the transition latency from tens of microseconds to only a fraction of that, thereby improving both power efficiency and system responsiveness. The dynamic reference technique represented by the curve 420 thus offers a more efficient way to implement voltage adjustments within a DVFS framework, particularly in an SoC where performance-state changes may occur frequently.

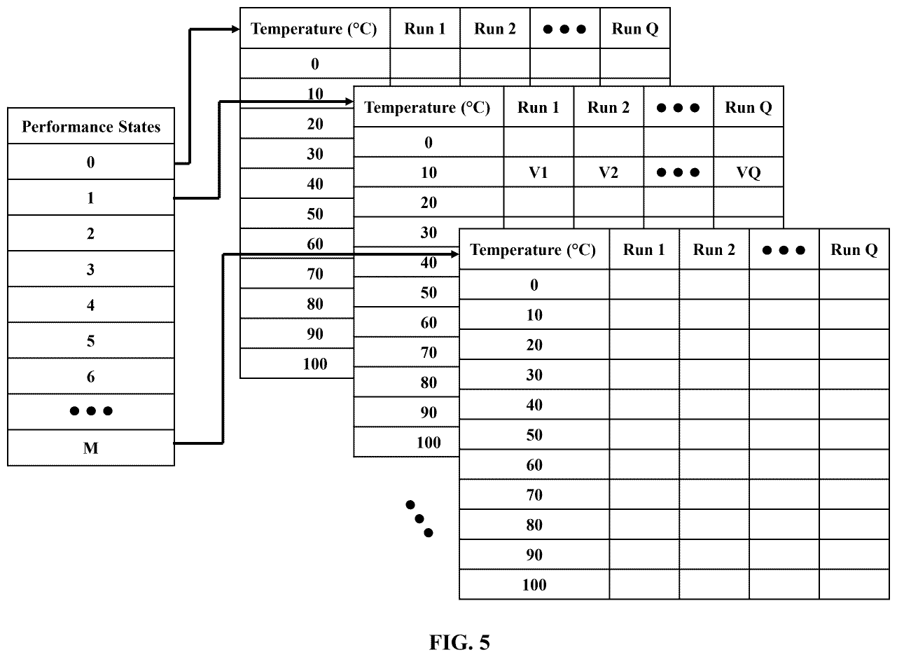

FIG. 5 illustrates an exemplary data structure and workflow for determining a dynamic reference voltage V_{D-REF} based on historical settled voltages (e.g., previous V_{TARGET}) recorded under various performance states and operating conditions (e.g., temperature), such that the determined dynamic reference voltage would lie closer to the new target voltage to settle to. In this illustrated arrangement, each performance state (labeled 0 through M) is associated with one or more tables, each covering a specific temperature range (e.g., 0° C., 10° C. . . . 100° C.). Within each table, columns labeled “Run 1,” “Run 2,” . . . “Run Q” store previously settled voltages corresponding to transitions into that particular performance state under the relevant temperature. “Run 1” may hold the earliest recorded settled voltage still tracked in the system, whereas “Run Q” holds the most recent settled voltage. The tables may be stored in tightly coupled memory (TCM), DDR, or other memory devices, such as in the memory 104.

To operate, the system firmware or other control logic (e.g., the CPR controller 204) first identifies the applicable performance state and temperature range for an impending DVFS transition, such as from the performance information received from the PDP 216. It then retrieves the relevant table row and reads out the historical voltages from the “Run 1” through “Run Q” entries. An algorithm, such as a linear weighted moving average (LWMA), is applied to these data points to generate a new dynamic reference voltage V_{D-REF}. For example, more recent settled voltages (e.g., “Run Q” and “Run Q-1”) may receive higher weights than older entries. Alternatively, a simpler rule, such as selecting the maximum among these recorded values, may be used. The final computed V_{D-REF} is then rounded or clamped to align with the discrete voltage steps that the PMIC 118 can provide, ensuring that the resulting reference voltage is valid and does not risk undervoltage or overshoot conditions.

Taking the table in FIG. 5 corresponding to P-state “1” as an example, when the CPR controller 204 receives a DVFS request to transition a processor to P-State “1”, the CPR controller 204 obtains the performance information from the PDP 216 indicating that the temperature is approximately “10° C.” Based on this information, the CPR controller 204 retrieves from memory 104 the table corresponding to P-State “1” and the “10° C.” entry. Assume this entry records the most recent four (i.e., Q=4) settled voltages. Thus, the system retains four recently stored settled voltages V1, V2, V3, and V4 from respective columns labeled “Run 1,” “Run 2,” “Run 3,” and “Run 4”. The most recent settled voltage is V4, while V1 is the earliest value still tracked in the system. A linear weighted moving average (LWMA) algorithm may weight these four voltages at 40%, 30%, 20%, and 10%, respectively, to compute an intermediate reference voltage as V_{D-REF}=40%*V4+30%*V3+20%*V2+10%*V1. Alternatively, the algorithm may simply select the maximum of the four voltages (e.g., V_{D-REF}=max (V1, V2, V3, V4)) or calculate their arithmetic mean (e.g., V_{D-REF}=(V1+V2+V3+V4)/4).

Once the CPR controller 204 has computed V_{D-REF}, it initiates the transition by commanding the respective voltage regulator(s) in the PMIC 118, which correspond to the power domain of the particular processor for P-state transition, to move from the current supply level toward V_{D-REF}. Because V_{D-REF} is typically much closer to the V_{TARGET}, than a conventional fixed reference voltage (V_{REF} in FIG. 4), fewer incremental steps are required to reach the final settling point, thereby reducing transition latency and transient power overhead. After the transition completes and the system confirms that V_{TARGET} has stabilized, the table is updated—the oldest stored value (e.g., “Run 1”) is discarded or shifted, and the new settled voltage is written into “Run Q”, preserving a rolling history of the most recent Q runs.

Notably, in addition to sorting entries according to temperature ranges in the table, the tables may track other environmental conditions or performance conditions (e.g., utilization rate of a processor), such as by using a multi-indexing table. Each P-state can therefore have multiple records corresponding to different temperature bands and/or other conditions. If external triggers, such as sudden temperature spikes or system load changes, place the resulting reference voltage outside of recommended safety bands, the system can revert to a higher ceiling reference to avoid undervolting. Firmware or control logic (e.g., CPUCP or PDP modules) may implement this flow by triggering a dedicated routine whenever P-state changes occur. Because DVFS requests are generally asynchronous, the P-state aggregator logic ensures these reference voltage calculations and table updates do not unduly interrupt critical workloads. Further refinements may include hysteresis or timing logic that refreshes the table at controlled intervals to account for thermal transients or cluster-level power states. For example, if one or more voltage values (e.g., V1) have been stored in the table for longer than a predetermined time period (e.g., over half an hour), the voltage value may be retired and replaced with a ceiling reference (e.g., V_{REF}).

Over time, these updates allow the data in FIG. 5's tables to evolve to reflect actual operating conditions, including temperature drift, silicon aging, or workload-dependent variations. Thus, each subsequent DVFS request can leverage progressively refined historical data, producing a V_{D-REF} that more accurately reflects current conditions. This adaptive strategy further shortens settling times and improves power efficiency in scenarios where performance -state transitions are frequent.

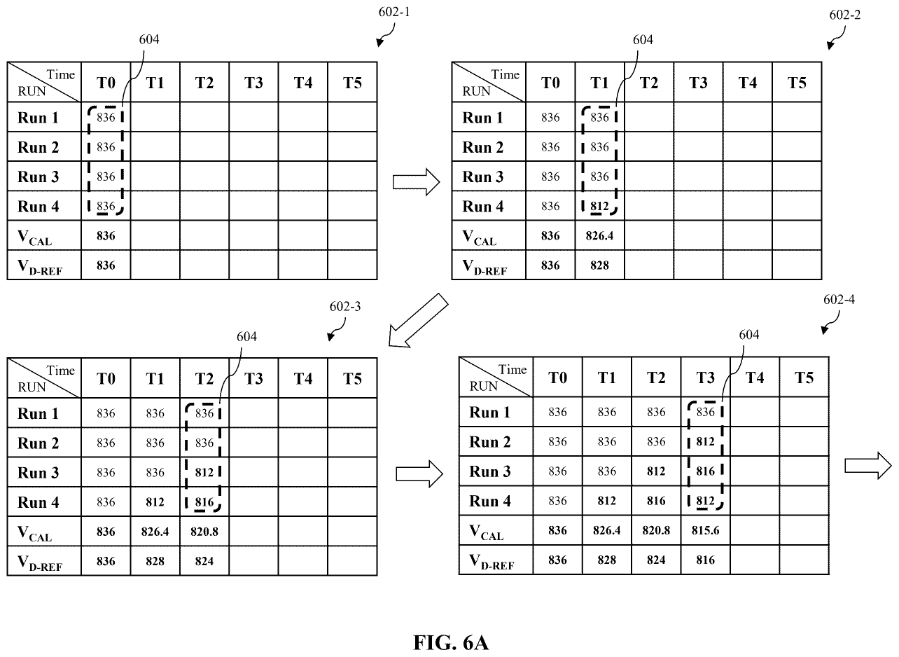

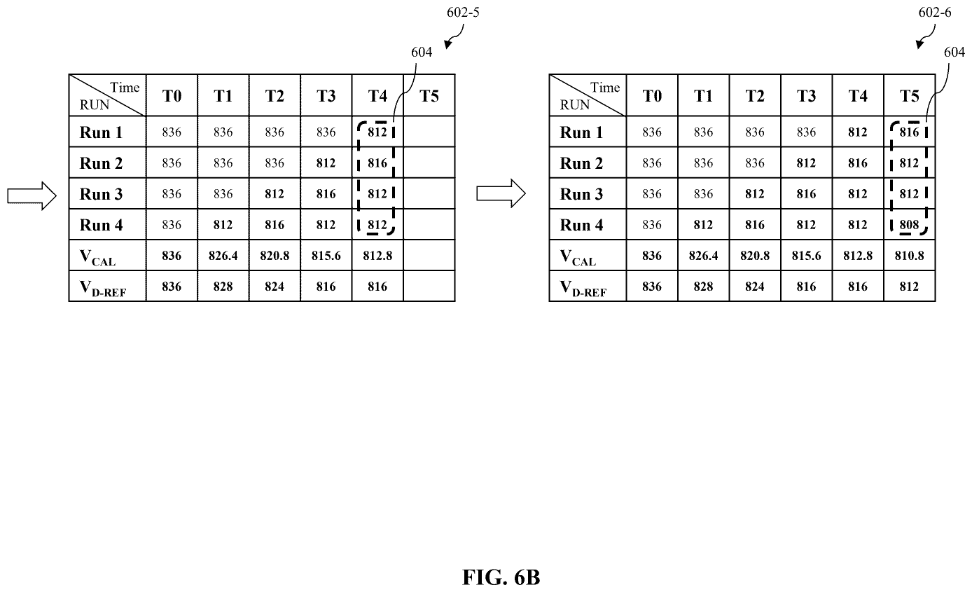

The tables in FIG. 5 illustrate how each performance state and temperature range is associated with historical data stored in the columns “Run 1” through “Run Q” of the respective table, from which the system uses to compute the dynamic reference voltage V_{D-REF}. FIG. 5 thus provides a high-level view of how the CPR controller 204 references past settled voltages in order to adapt each new DVFS transition. FIGS. 6A and 6B collectively illustrate, through a particular example (e.g., Q=4, ceiling voltage at 836 mV, and a step ΔV of 4 mV), that step by step how these tables are updated over time and how the system calculates V_{D-REF} during successive transitions. FIGS. 6A and 6B show six calculation sheets 602-1 to 602-6 corresponding to six moments (e.g., T0 to T5) that a DVFS request is triggered, each of which depicts an incremental snapshot of the run data, the intermediate computation for a calculated V_{D-REF} (denoted as V_{CAL}), and the final chosen value for V_{D-REF}. In each of the calculation sheets 602-1 to 602-6, the column as highlighted in a dashed box 604 corresponding to “Run 1” to “Run 4”0 is the data saved in a respective row in a respective table corresponding to the performance state in FIG. 5.

Referring to the calculation sheet 602-1, immediately after a cold-boost event at time T0, the CPR controller 204 receives a new DVFS request targeting a final voltage (e.g., 812 mV). Because the system has just powered up and no prior settling data exists, each of the four historical “RUN” columns (“Run 1” to “Run 4”) in the table is initialized to a default ceiling value (e.g., 836 mV). The linear weighted moving average (LWMA) then computes a provisional reference voltage V_{CAL} at 836 mV (40%*V4+30%*V3+20%*V2+10%*V1=836 mV, in which V4=V3=V2=V1=836 mV). After rounding or clamping to an available PMIC step, V_{D-REF} is also set as 836 mV. The CPR controller 204 and PMIC 118 therefore decrement from 836 mV down to 812 mV step by step (e.g., ΔV=4 mV), which requires multiple intermediate steps (e.g., 836→832→828→824→820→816→812 mV). Although no optimization is achieved in this initial cold-boost scenario, the final settled value of 812 mV is stored to the next sheet (calculation sheet 602-2) as the most recent settled voltage (“Run 4”).

Moving to the calculation sheet 602-2, at time T1, another DVFS request arrives, for instance requesting 816 mV. The historical table now contains three values still at 836 mV (“Run 1” to “Run 3”) and one updated entry at 812 mV (“Run 4”). Applying the LWMA yields a provisional V_{CAL} of 826.4 mV (40%*V4+30%*V3+20%*V2+10%*V1=826.4 mV, in which V3=V2=V1=836 mV and V4=812 mV), which rounds or clamps to 828 mV as the value for V_{D-REF}. Because this updated reference of 828 mV is closer to the target than 836 mV, the number of 4 mV decrements is reduced. The system only steps through 828→824→820→816 mV, omitting the extra two steps that would otherwise be necessary from 836 mV (836→832→828 mV). Once the voltage settles at 816 mV, that result becomes the newly recorded settled voltage to store in “Run 4” with the previous 812 mV shifting to “Run 3” in the next sheet (calculation sheet 602-3).

Moving to the calculation sheet 602-3, at time T2, another DVFS request arrives, for instance requesting 812 mV. The historical table now contains two values still at 836 mV (“Run 1” and “Run 2”) and two recently updated entries at 812 mV (“Run 3”) and 816 mV (“Run 4”). Applying the LWMA yields a provisional V_{CAL} of 820.8 mV (40%*V4+30%*V3+20%*V2+10%*V1=820.8 mV, in which V2=V1=836 mV, V3=812 mV, and V4=816mV), which rounds or clamps to 824 mV as the value for V_{D-REF}. Because this updated reference of 824 mV is closer to the target than 836 mV, the number of 4 mV decrements is reduced. The system only steps through 824→820→816→812 mV, omitting the extra three steps that would otherwise be necessary from 836 mV (836→832→828→824 mV). Once the voltage settles at 812 mV, that result becomes the newly recorded settled voltage to store in “Run 4” with the previous 816 mV shifting to “Run 3” and 812 mV shifting to “Run 2” in the next sheet (calculation sheet 602-4).

Moving to the calculation sheet 602-4, at time T3, another DVFS request arrives, for instance requesting 812 mV again. The historical table now contains one value still at 836 mV (“Run 1”) and three recently updated entries at 812 mV (“Run 2”), 816 mV (“Run 3”), and 812 mV (“Run 4”). Applying the LWMA yields a provisional V_{CAL} of 815.6 mV (40%*V4+30%*V3+20%*V2+10%*V1=820.8 mV, in which V1=836 mV, V2=812 mV, V3=816 mV, and V4=812 mV), which rounds or clamps to 816 mV as the value for V_{D-REF}. Because this updated reference of 816 mV is closer to the target than 836 mV, the number of 4 mV decrements is reduced. The system only steps through 816→812 mV, omitting the extra five steps that would otherwise be necessary from 836 mV (836→832→828→824→820→816 mV). Once the voltage settles at 812 mV, that result becomes the newly recorded settled voltage to store in “Run 4” with the previous 812 mV shifting to “Run 3”, 816 mV shifting to “Run 2”, and 812 mV shifting to “Run 1” in the next sheet (calculation sheet 602-5).

Moving to the calculation sheet 602-5, at time T4, another DVFS request arrives, for instance requesting 808 mV. The historical table now contains four recently updated entries at 812 mV (“Run 1”), 816 mV (“Run 2”), 812 mV (“Run 3”), and 812 mV (“Run 4”). Applying the LWMA yields a provisional V_{CAL} of 812.8 mV (40%*V4+30%*V3+20%*V2+10%*V1=820.8 mV, in which V1=812 mV, V3=816 mV, V3=812 mV, and V4=812 mV), which rounds or clamps to 816 mV as the value for V_{D-REF}. Because this updated reference of 816 mV is closer to the target than 836 mV, the number of 4 mV decrements is reduced. The system only steps through 816→812 mV, omitting the extra five steps that would otherwise be necessary from 836 mV (836→832→828→824→820→816 mV). Once the voltage settles at 808 mV, that result becomes the newly recorded settled voltage to store in “Run 4” with the previous 812 mV shifting to “Run 3”, 812 mV shifting to “Run 2”, and 816 mV shifting to “Run 1” in the next sheet (calculation sheet 602-6). Notably, the previous data 812 mV as stored in “Run 1”0 has been flushed out in the calculation sheet 602-6 by the system, as the system tracks the four most recent settled voltages in the illustrated example with Q=4. It is apparent to those of ordinary skill in the art that Q=4 is a non-limiting example, and in various other implementations the system may track any number of most recent settled voltages including less than 4 or larger than 4.

Moving to the calculation sheet 602-6, at time T5, another DVFS request arrives, for instance requesting 808 mV. The historical table now contains four recently updated entries at 816 mV (“Run 1”), 812 mV (“Run 2”), 812 mV (“Run 3”), and 808 mV (“Run 4”). Applying the LWMA yields a provisional V_{CAL} of 810.8 mV (40%*V4+30%*V3+20%*V2+10%*V1=820.8 mV, in which V1=816 mV, V3=812 mV, V3=812 mV, and V4=808 mV), which rounds or clamps to 812 mV as the value for V_{D-REF}. Because this updated reference of 812 mV is closer to the target than 836 mV, the number of 4 mV decrements is reduced. The system only steps through 812→808 mV, omitting the extra six steps that would otherwise be necessary from 836 mV (836→832→828→824→820→816→812 mV).

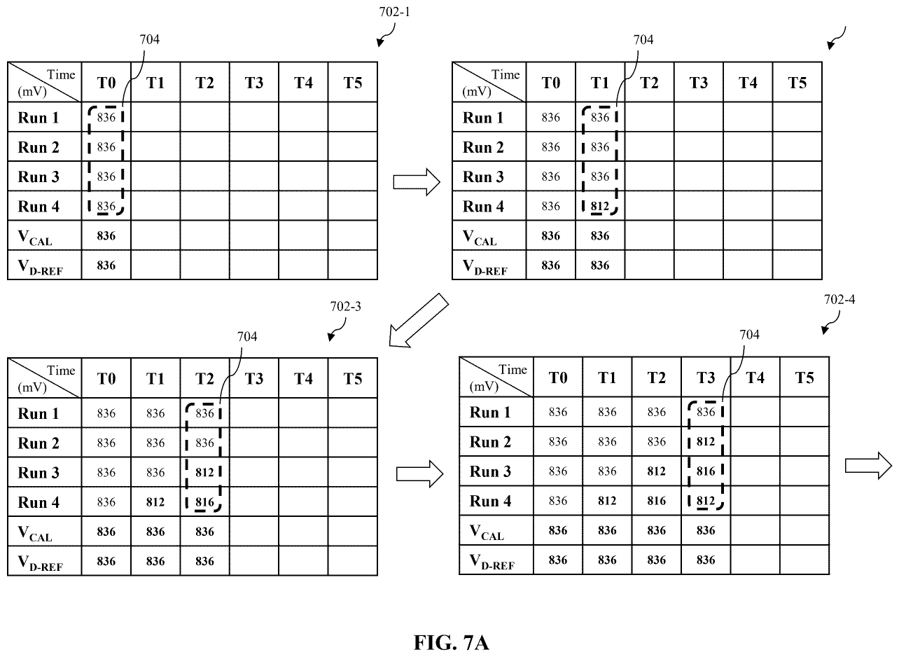

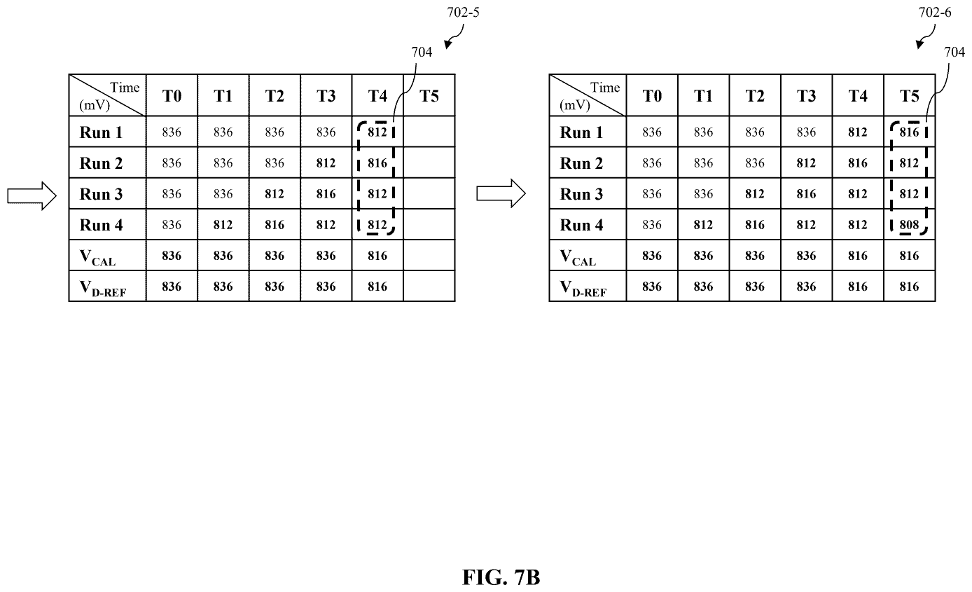

In the above example of calculation sheets 602-1 to 602-6, LWMA is used to calculate a provisional reference voltage V_{CAL} to determine a value for the dynamic reference voltage V_{D-REF}. In some implementations, an alternative algorithm other than LWMA (e.g., selecting the maximum value or selecting a mean value) may be applied to determine a value for V_{D-REF}. FIGS. 7A and 7B collectively illustrate such an example, in which the maximum one of the historical settled voltages is picked as V_{D-REF}.

Similarly to FIGS. 6A and 6B, FIGS. 7A and 7B collectively illustrate, through a particular example (e.g., Q=4, ceiling voltage at 836 mV, and a step ΔV of 4 mV), that step by step how calculation tables 702-1 to 702-6 are updated over time and how the system calculates V_{D-REF} during successive transitions. The calculation sheets 702-1 to 702-6 corresponding to six moments (e.g., T0 to T5) that a DVFS request is triggered, each of which depicts an incremental snapshot of the run data, the intermediate computation for a calculated V_{D-REF} (denoted as V_{CAL}), and the final chosen value for V_{D-REF}. In each of the calculation sheets 702-1 to 702-6, the column as highlighted in a dashed box 704 corresponding to “Run 1” to “Run 4” is the data saved in a respective row in a respective table corresponding to the performance state in FIG. 5.

Referring to the calculation sheet 702-1, immediately after a cold-boot event at time T0, the CPR controller 204 receives a new DVFS request targeting a final voltage (e.g., 812 mV). Because the system has just powered up and no prior settling data exists, each of the four historical “RUN” columns (“Run 1” to “Run 4”) in the table is initialized to a default ceiling value (e.g., 836 mV). The algorithm then picks the maximum value from “Run 1” to “Run 4”, which is 836 mV, as the value for V_{D-REF}. The CPR controller 204 and PMIC 118 therefore decrement from 836 mV down to 812 mV step by step (e.g., ΔV=4 mV), which requires multiple intermediate steps (e.g., 836→832→828→824→820→816→812 mV). The final settled value of 812 mV is stored to the next sheet (calculation sheet 702-2) as the most recent settled voltage (“Run 4”).

Moving to the calculation sheet 702-2, at time T1, another DVFS request arrives, for instance requesting 816 mV. The historical table now contains three values still at 836 mV (“Run 1” to “Run 3”) and one updated entry at 812 mV (“Run 4”). The algorithm once again picks the maximum value from “Run 1” to “Run 4”, which is 836 mV, as the value for V_{D} _{-REF}. The CPR controller 204 and PMIC 118 therefore decrement from 836 mV down to 816 mV step by step (e.g., ΔV=4 mV), which requires multiple intermediate steps (e.g., 836→832→828→824→820→816 mV). Once the voltage settles at 816 mV, that result becomes the newly recorded settled voltage to store in “Run 4” with the previous 812 mV shifting to “Run 3” in the next sheet (calculation sheet 702-3).

Moving to the calculation sheet 702-3, at time T2, another DVFS request arrives, for instance requesting 812 mV. The historical table now contains two values still at 836 mV (“Run 1” and “Run 2”) and two recently updated entries at 812 mV (“Run 3”) and 816 mV (“Run 4”). The algorithm once again picks the maximum value from “Run 1” to “Run 4”, which is 836 mV, as the value for V_{D-REF}. The CPR controller 204 and PMIC 118 therefore decrement from 836 mV down to 812 mV step by step (e.g., ΔV=4 mV), which requires multiple intermediate steps (e.g., 836→832→828→824→820→816→812 mV). Once the voltage settles at 812 mV, that result becomes the newly recorded settled voltage to store in “Run 4” with the previous 816 mV shifting to “Run 3” and 812 mV shifting to “Run 2” in the next sheet (calculation sheet 702-4).

Moving to the calculation sheet 702-4, at time T3, another DVFS request arrives, for instance requesting 812 mV again. The historical table now contains one value still at 836 mV (“Run 1”) and three recently updated entries at 812 mV (“Run 2”), 816 mV (“Run 3”), and 812 mV (“Run 4”). The algorithm once again picks the maximum value from “Run 1” to “Run 4”, which is 836 mV, as the value for V_{D-REF}. The CPR controller 204 and PMIC 118 therefore decrement from 836 mV down to 812 mV step by step (e.g., ΔV=4 mV), which requires multiple intermediate steps (e.g., 836→832→828→824→820→816→812 mV). Once the voltage settles at 812 mV, that result becomes the newly recorded settled voltage to store in “Run 4” with the previous 812 mV shifting to “Run 3”, 816 mV shifting to “Run 2”, and 812 mV shifting to “Run 1” in the next sheet (calculation sheet 702-5).

Moving to the calculation sheet 702-5, at time T4, another DVFS request arrives, for instance requesting 808 mV. The historical table now contains four recently updated entries at 812 mV (“Run 1”), 816 mV (“Run 2”), 812 mV (“Run 3”), and 812 mV (“Run 4”). The algorithm picks the maximum value from “Run 1” to “Run 4”, which is 816 mV, as the value for V_{D-REF}. Because this updated reference of 816 mV is closer to the target than 836 mV, the number of 4 mV decrements is reduced. The system only steps through 816→812 mV, omitting the extra five steps that would otherwise be necessary from 836 mV (836→832→828→824→820→816 mV). Once the voltage settles at 808 mV, that result becomes the newly recorded settled voltage to store in “Run 4” with the previous 812 mV shifting to “Run 3”, 812 mV shifting to “Run 2”, and 816 mV shifting to “Run 1” in the next sheet (calculation sheet 702-6). From now on, the newly determined V_{D-REF} in the next event will be closer to the historical settled values and reduces transition latency. Notably, the previous data 812 mV as stored in “Run 1” has been flushed out in the calculation sheet 702-6 by the system, as the system tracks the four most recent settled voltages in the illustrated example with Q=4. is apparent to those of ordinary skill in the art that Q=4 is a non-limiting example, and in various other implementations the system may track any number of most recent settled voltages including less than 4 or larger than 4.

Moving to the calculation sheet 702-6, at time T5, another DVFS request arrives, for instance requesting 808 mV. The historical table now contains four recently updated entries at 816 mV (“Run 1”), 812 mV (“Run 2”), 812 mV (“Run 3”), and 808 mV (“Run 4”). The algorithm picks the maximum value from “Run 1” to “Run 4”, which is 816 mV, as the value for V_{D-REF}. Because this updated reference of 816 mV is closer to the target than 836 mV, the number of 4 mV decrements is reduced. The system only steps through 816→812→808mV, omitting the extra five steps that would otherwise be necessary from 836 mV (836→832→828→824→820→816 mV).

As depicted in FIGS. 6A-B and 7A-B, the historical data in the tables stored in the memory of the system evolves over time to reflect each device's actual operating conditions—whether the silicon is “fast” or “slow” including variations from temperature drift, silicon aging, and workload changes. As these tables are updated, subsequent DVFS requests can increasingly rely on refined historical data to compute a dynamic reference voltage that more closely matches current conditions. This adaptive strategy also allows for real-time tuning of the PMIC's setting of ceiling and floor voltages. For example, when the system identifies that the silicon is a “slow” silicon, the default ceiling voltage of 836 mV might be raised to 844 mV and the default floor voltage raised from 800 mV to 808 mV, thereby ensuring more stable operation. Rather than settling at the floor voltage of 800 mV, a “slow” silicon can now settle at 808 mV under the same conditions. Conversely, if the silicon is recognized as a “fast” silicon, the same mechanism could lower the default ceiling from 836 mV to 800 mV and shift the default floor to 768 mV, enabling the “fast” silicon to settle at a final voltage even lower than the otherwise fixed floor voltage, such as 780 mV, to achieve further power savings.

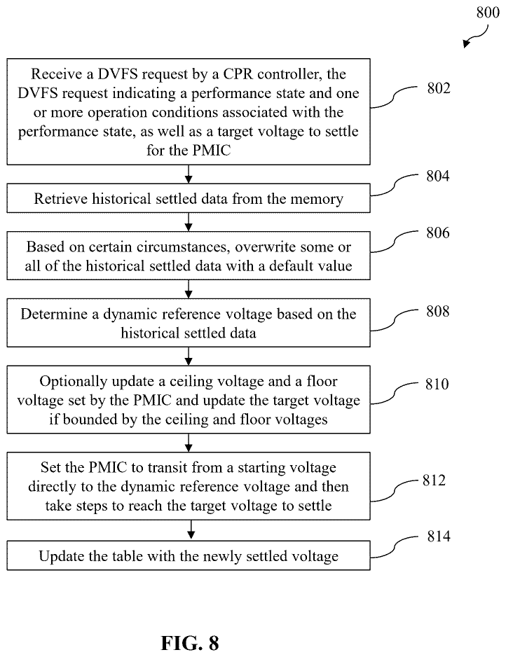

FIG. 8 is a flowchart illustrating an exemplary method 800 for managing DVFS transitions to reduce settling time on voltage supplies based on historical settled voltages in an electronic device. At step 802, the CPR controller 204 receives a DVFS request indicating a desired performance state and one or more operating conditions, such as temperature and/or a utilization rate of a processor. The request also specifies a target voltage to be supplied by the PMIC so that the device can meet the performance requirements (e.g., clock frequency, processing load) associated with the requested performance state. In certain arrangements, this request may originate from the PDP 216.

At step 804, the CPR controller 204 accesses the memory 104 (or another designated storage location) to retrieve the historical settled data associated with the specified performance state and operating conditions (e.g., temperate and/or utilization rate of the processor). The retrieved data typically includes a set of recently settled voltages (e.g., “Run 1” through “Run Q” in FIG. 5) that reflect how the system actually settled in the past.

At step 806, the system optionally overwrites some or all of the retrieved historical data with a default value, depending on current circumstances. For instance, if the system has just emerged from a cold-boost scenario, or if an integrity check indicates that the stored data is outdated (e.g., the stored data may be associated with a time stamp at its creation, and the system retires the data that has existed longer than a predetermined period, such as half an hour) or out of bounds, a conservative ceiling voltage may be re-injected into each entry. This ensures safe operation when the stored information may no longer accurately represent the device's real-time characteristics.

At step 808, the CPR controller 204 computes a dynamic reference voltage V_{D-REF} using the historical data, possibly applying a linear weighted moving average or another suitable algorithm (e.g., maximum, median, or mean). By adaptively incorporating recent measurements, the controller arrives at a reference voltage that is typically closer to the eventual target voltage than a fixed default reference voltage V_{REF}. This more accurate starting point reduces the total number of incremental steps needed to reach the final voltage, thereby saving both time and energy during the transition.

Optionally, at step 810, the controller evaluates whether the dynamic reference voltage warrants adjusting the PMIC's nominal ceiling and floor voltages. For example, if the system identifies “slow” silicon behavior, it may raise the ceiling and floor slightly to ensure sufficient headroom and reduce the risk of undervoltage. Conversely, for “fast” silicon, it may lower these thresholds to capture additional power savings. If the requested target voltage is bounded by the fixed ceiling or floor voltages, the controller may re -adjust the target voltage to take advantages from the updated ceiling and floor voltages.

At step 812, the CPR controller 204 commands the PMIC 118 to transition from the current supply level directly to the determined dynamic reference voltage V_{D-REF}. Because this reference is typically closer to the target than a fixed reference voltage V_{REF} would be, fewer steps are required to reach the final voltage. The PMIC 118 may then decrement or increment the supply rail in small voltage steps (e.g., 4 mV steps) until the target voltage is attained. These steps ensure stable operation by allowing each intermediate level to settle within an acceptable time window.

At step 814, once the voltage has stabilized at the target value, the CPR controller 204 writes the confirmed final settled voltage back into the table stored in the memory 104, overwriting the oldest entry or shifting the existing run data accordingly. This newly stored data updates the historical data set for future DVFS requests. Over multiple iterations, this feedback loop enables the system to refine V_{D-REF}, as well as ceiling and/or floor bounds, so that subsequent transitions become progressively faster and more power efficient.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

Additionally, one of ordinary skill in power management within a portable computing device is able to identify appropriate hardware and/or circuits and/or identify appropriate logic and determinations to implement the disclosed invention without difficulty based on the flow charts and associated description in this specification. Therefore, disclosure of a particular set of program code instructions, decision thresholds or detailed hardware devices is not considered necessary for an adequate understanding of how to make and use the invention. The inventive functionality and aspects of the claimed processor-enabled processes and circuit architectures are explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored as one or more instructions or code on a computer-readable medium, such as a non-transitory processor-readable medium. Computer-readable media include data storage media.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present systems and methods, as defined by the following claims.

What is claimed is

1. A method for dynamically controlling power consumption of an electronic device, the electronic device including at least one processor operable under a plurality of performance states and a power management device configured to power the processor, the method comprising:
generating a request indicating a selected performance state from the plurality of performance states for the processor to shift to;
determining a target supply voltage associated with the selected performance state;
retrieving a plurality of historical supply voltages associated with the selected performance state;
determining a reference voltage from the plurality of historical supply voltages; and
setting the power management device to ramp to the reference voltage and step to the target supply voltage from the reference voltage.

2. The method of claim 1, wherein the plurality of historical supply voltages are associated with an operating temperature of the processor indicated in the request.

3. The method of claim 1, wherein the plurality of historical supply voltages are retrieved from a table stored in a memory device of the electronic device.

4. The method of claim 3, wherein the table is one of a plurality of tables stored in the memory device, wherein each of the tables is associated with a different one of the performance states.

5. The method of claim 1, wherein the determining of the reference voltage includes calculating a weighted value from the plurality of historical supply voltages as a value for the reference voltage.

6. The method of claim 5, wherein a most recent one of the historical supply voltages carries a largest weight factor during the calculating of the weighted value.

7. The method of claim 1, wherein the determining of the reference voltage includes selecting a largest one from the historical supply voltages as a value for the reference voltage.

8. The method of claim 1, further comprising:
in a condition of the request being a first request after a cold boot, assigning a fixed value to the plurality of historical supply voltages.

9. The method of claim 1, further comprising:
in a condition of one of the historical supply voltages expires, assigning a fixed value to the expired one of the historical supply voltages.

10. The method of claim 1, wherein the dynamically controlling power consumption is part of a dynamic voltage and frequency scaling (DVFS) process.

11. A system for dynamically controlling power consumption of an electronic device, comprising:
a processor;
a power management processor associated with the processor;
a voltage regulator providing a supply voltage to the processor; and
a controller commanding the voltage regulator to provide the supply voltage,
wherein the controller is configured to:
receive a request generated from the power management processor, the request indicating a performance state for the processor to shift to and a target supply voltage associated with the performance state;
retrieve a plurality of historical supply voltages associated with the performance state;
determine a reference voltage from the plurality of historical supply voltages; and
command the voltage regulator to shift the supply voltage to the reference voltage first then from the reference voltage to the target supply voltage.

12. The system of claim 11, wherein the plurality of historical supply voltages are associated with a same temperature indicated in the request.

13. The system of claim 11, wherein the controller is further configured to:
store the target supply voltage as a latest one of the historical supply voltages.

14. The system of claim 13, wherein the controller is further configured to:
removing an earliest one of the historical supply voltages.

15. The system of claim 11, wherein the reference voltage is determined by calculating a weighted value from the plurality of historical supply voltages.

16. The system of claim 11, wherein the reference voltage is determined by selecting a largest value from the historical supply voltages.

17. The system of claim 11, wherein the supply voltage provided to the processor is bounded by a ceiling value and a floor value, wherein the controller is further configured to:
update the ceiling value and the floor value based on the determined reference voltage.

18. An apparatus, comprising:
a processor operable to shift under a plurality of performance states;
a first means for determining a next performance state for the processor from the plurality of performance states and a target supply voltage associated with the next performance state; and
a second means for controlling a supply voltage for the processor configured to:
retrieve a plurality of historical supply voltages associated with the next performance state;
determine a reference voltage based on the historical supply voltages; and
ramp the supply voltage to the determined reference voltage and step to the target supply voltage from the determined reference voltage.

19. The apparatus of claim 18, wherein the second means is further configured to:
add the target supply voltage as a latest one of the plurality of historical supply voltages; and
remove an earliest one of the plurality of historical supply voltages.

20. The apparatus of claim 18, wherein the plurality of historical supply voltages are retrieved from one of a series of tables stored in a memory device, wherein each of the series of tables is associated with one of the performance states.
